(19) United States
(12) Patent Application Publication
(10) Pub. No.: US 2024/0316984 A1
(43) Pub. Date: Sep. 26, 2024

(54) CONTAINER CANDLE WITH HEAT-ACTIVATED DECORATIVE DESIGN

(71) Applicant: Kelly Rucker, Huntingdon, PA (US)

(72) Inventors: Kelly Rae Rucker, Huntingdon, PA (US); Jerry Lynn Rucker, Huntingdon, PA (US)

(21) Appl. No.: 18/210,369

(22) Filed: Jun. 15, 2023

Related U.S. Application Data
(60) Provisional application No. 63/453,755, filed on Mar. 21, 2023.

(51) Int. Cl. B44F 1/10; F21V 35/00

(52) U.S. Cl. CPC B44F 1/10; F21V 35/00

(57) ABSTRACT

A system for revealing an image affixed to a candle is provided. The system comprises a candle contained within a vessel and a design adhering to an exterior surface of the vessel. The design comprises an inner layer displaying a static image and an outer layer at least partially covering and at least partially concealing the inner layer. The outer layer receives thermal energy based on a lighting of the container candle. The outer layer changes, based on an increasing level of thermal energy, at least one of colors and opacity. Based at least on the changing of the at least one of colors and opacity, the outer layer exposes the static image. The vessel is made of at least one of glass, ceramic and heat-resistant plastic. The vessel is one of translucent, transparent or opaque. The candle contains one of a single wick and multiple wicks.

### CROSS REFERENCE TO RELATED APPLICATIONS

The present non-provisional patent application is related to U.S. Provisional Patent Application No. 63/453,755 filed Mar. 21, 2023, the contents of which are incorporated herein in their entirety.

### FIELD OF THE DISCLOSURE

The present disclosure is in the field of interior furnishings and candles. More particularly, the present disclosure provides a container candle bearing an externally attached dual layer design, an inner layer bearing a static image and an outer layer that slowly dissipates based on thermal energy, the dissipation causing the previously concealed static image to become gradually visible.

### BACKGROUND

Pillar candles stand on their own and support a central wick. Free standing candles must be affixed into an appropriate candle holder or placed on a heat-resistant surface to be burned.

Container candles comprise wax that is poured into a rigid container with a wick affixed to the container. The wax and wick are not removable from the container, and a separate candle holder is not necessary.

### BRIEF DESCRIPTION OF THE FIGURES

FIG. 1 is a diagram of a container candle with heat-activated decorative design according to an embodiment of the present disclosure.

FIG. 2 is a diagram of a container candle with heat-activated decorative design according to an embodiment of the present disclosure.

FIG. 3 is a diagram of a container candle with heat-activated decorative design according to an embodiment of the present disclosure.

FIG. 4 is a diagram of a container candle with heat-activated decorative design according to an embodiment of the present disclosure.

### DETAILED DESCRIPTION

The present disclosure provides a container candle and a heat-activated design on an external surface of the candle. The heat-activated design shall be achieved through a label application or direct print onto the candle container. The heat-activated design comprises an inner layer and an outer layer. The outer layer partially or completely covers and conceals the inner layer.

It may not be possible for an observer to see any of the inner layer through the outer layer when the candle is not lit. The existence of the inner layer may not even be apparent at all via viewing of the candle and the heat-activated design. The heat-activated design may entirely encircle or otherwise envelop the circumference of the container candle, or it may cover merely a portion of the outer surface of the container candle which may be circular in circumference or may have a circumference of another shape.

The inner layer is decorated or fitted with a printed image that is partially or entirely covered by the outer layer. The outer layer is designed to react to the thermal energy produced from the candle flame by changing color or opacity when the wick is lit.

The effect is that the appearance of the top printed layer changes to reveal all or part of the static image on the inner layer that was not visible before the wick was lit.

The container candle provided herein exhibits significant advantages over previous implementations. The present candle does not require a candle to be affixed to the candle holder as in U.S. Pat. No. 10,676,691 B2, since the form is a container candle where the wax is integral to the container. Container candles are by far the most popular type of candles on the market today since consumers prefer not to have the inconvenience of a separate candle and candle holder.

The container candle provided herein does not have two separate thermochromic ink layers as in U.S. Pat. No. 10,676,691 in which two layers activate at two separate ambient temperatures. Instead, in the present system, one layer is a static image generated by standard printing or labeling means. Only the top layer is reactive to the thermal energy from the lit wick, simplifying the design and execution.

In the system provided herein, placement of the printed layer or label is ideally at the top of the container candle above the wax level. This allows the thermal energy from the lit wick to reach the printed layer or label before the entire candle wax is consumed. This feature promotes earlier and longer enjoyment of the changing feature.

The heat-activated design has numerous applications for special occasions and gifting. One example is for baby showers and baby gender reveal parties. As the wax of the candle and the glass, ceramic, or plastic container or jar heat up, the outer layer eventually begins to absorb thermal energy or heat. The outer layer may then begin to transition or otherwise dissipate so that the image underneath on the inner layer begins to become visible. In this example, the gradual nature of the exposure of the image may be a method to announce the new baby's gender in a novel manner.

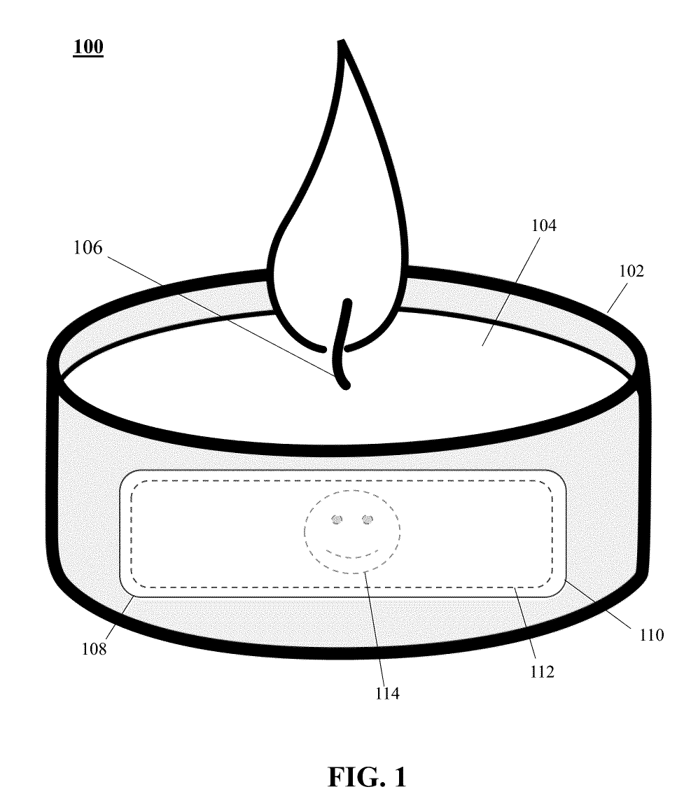

Turning to the figures, FIG. 1 is a diagram of a container candle with heat-activated decorative design according to an embodiment of the present disclosure. FIG. 1 depicts components of a system 100 comprising a container 102, wax 104, and wick 106. The system 100 also comprises a label or layer 108 which itself comprises an outer layer 110, an inner layer 112, and a static image 114 printed onto the inner layer 112. The inner layer 112 and the static image 114 are depicted as dotted lines as these are at least partially concealed by the outer layer 110.

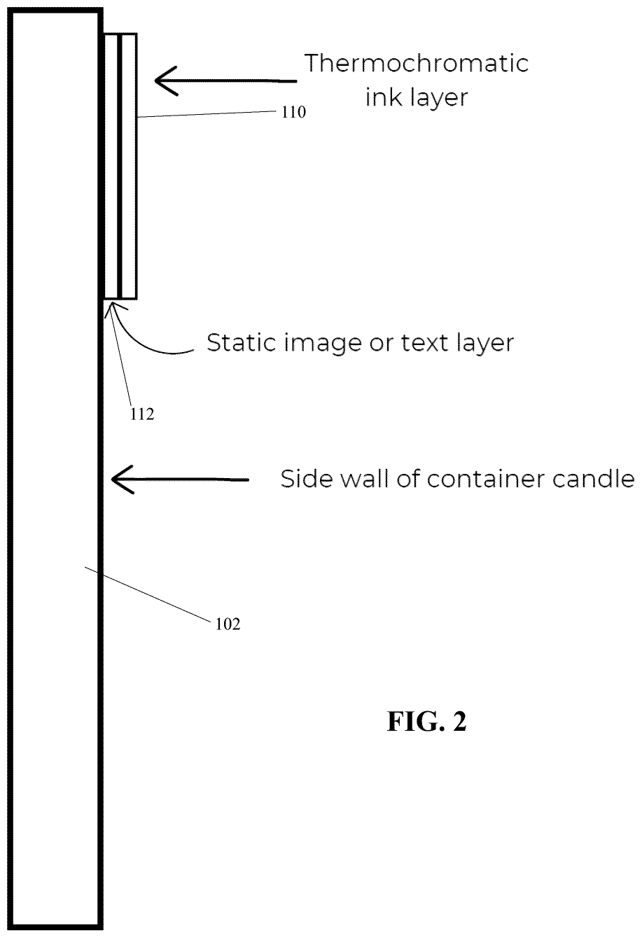

FIG. 2 is a diagram of a container candle with heat-activated decorative design according to an embodiment of the present disclosure. FIG. 2 provides a side cutaway view of the system 100 including the container 102, referred to in FIG. 2 as a side wall of container candle. Also included is the inner layer 112, referred to in FIG. 2 as a static image or text layer. Also included is the outer layer 110, referred to in FIG. 2 as a thermochromic ink layer.

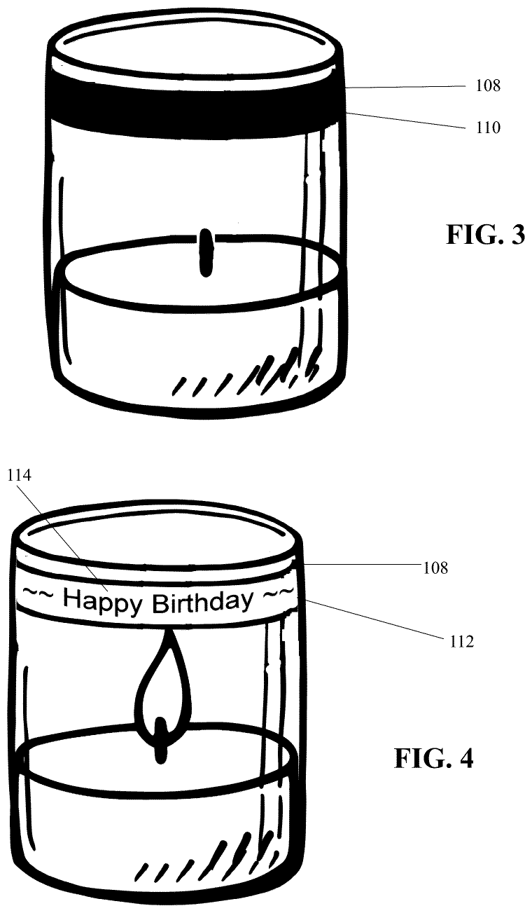

FIG. 3 is a diagram of a container candle with heat-activated decorative design according to an embodiment of the present disclosure. FIG. 3 illustrates the container candle when it is not lit and is at ambient state. There is no heat or thermal energy being radiated. The label 108 and the outer layer 110 are shown. The inner layer 112 is not shown as it is concealed.

FIG. 4 is a diagram of a container candle with heat-activated decorative design according to an embodiment of the present disclosure. The label or layer 108 and the inner layer 112 are shown as is the static image 114 attached to the inner layer which says Happy Birthday. In this diagram, the wick is shown in a lit state and thermal energy from the flame is heating the layers of the design causing the outer layer 110 to change state allowing the inner layer 112 to become visible exposing the static image 114.

In an embodiment, a system for revealing an image affixed to a candle is provided. The system comprises a candle contained within a vessel and a design adhering to an exterior surface of the vessel. The design comprises an inner layer displaying a static image and an outer layer at least partially covering and at least partially concealing the inner layer. The outer layer receives thermal energy based on a lighting of the container candle. The outer layer changes, based on an increasing level of thermal energy, at least one of colors and opacity. Based at least on the changing of the at least one of colors and opacity, the outer layer exposes the static image.

The vessel is made of at least one of glass, ceramic and heat-resistant plastic. The vessel is one of translucent, transparent or opaque.

The candle contains one of a single wick and multiple wicks. The outer layer is treated with at least one substance configured to react to increasing levels of thermal energy.

The candle is a container candle and remains in an upright position independent of supporting devices. The design is positioned at an upper area of the candle, the positioning promoting the thermal energy to reach the design before wax of the candle is consumed. Previous to the receipt of thermal energy by the outer layer, the static image is not visible.

In another embodiment, a method for exposing an image on a candle is provided. The method comprises an outer layer of a dual layer design affixed to an exterior surface of a candle detecting a thermal energy. The method also comprises the outer layer, based on the detection, commencing a change of a substance one of comprising the outer layer and adhering to the outer layer. The method also comprises the outer layer, based on the change, altering at least one of a color and opacity of the substance. The method also comprises the outer layer, based on the alteration, exposing a static image attached to an inner layer of the design.

The method also comprises the candle comprising a container candle. The method also comprises the outer layer detecting the thermal energy based on a lighting of one of a single wick and multiple wicks of the candle.

The method also comprises the outer layer at least one of partially and completely covering the inner layer. The alteration comprises a transition of the heat-activated ink caused by the thermal energy. The method also comprises the design initially receiving placement at an upper area of the candle, the placement promoting the thermal energy to reach the design before wax of the candle is consumed.

In yet another embodiment, a method for progressively exposing an image affixed to a candle is provided. The method comprises a candle radiating thermal energy based on at least one wick in the candle having been lit. The method also comprises the candle heating an outer layer of an externally attached two-layer design based on the radiated thermal energy. The method also comprises the candle, based on the energy, causing a substance at least one of coated onto and incorporated into the outer layer to dissipate. The method also comprises the candle, based on the dissipation, exposing a static image printed onto an inner layer of the design.

The candle causing the dissipation comprises the substance changing at least one of colors and opacity of the outer layer. The method also comprises the candle, via the outer layer, concealing the static image prior to the dissipation.

The candle is a container candle with a container made of one of at least glass, ceramic or heat-resistant plastic. The container is one of translucent, transparent or opaque. The method also comprises the design initially receiving placement at an upper area of the candle, the placement promoting the thermal energy to reach the design before wax of the candle is consumed.

What is claimed is:

1. A system for revealing an image affixed to a candle, comprising
a candle contained within a vessel;
a design adhering to an exterior surface of the vessel, the design comprising:
an inner layer displaying a static image, and
an outer layer at least partially covering and at least partially concealing the inner layer that:
receives thermal energy based on a lighting of the container candle,
changes, based on an increasing level of thermal energy, at least one of colors and opacity, and
based at least on the changing of the at least one of colors and opacity, exposes the static image.

2. The system of claim 1, wherein the vessel is made of at least one of glass, ceramic and heat-resistant plastic.

3. The system of claim 1, wherein the vessel is one of translucent, transparent or opaque.

4. The system of claim 1, wherein the candle contains one of a single wick and multiple wicks.

5. The system of claim 1, wherein the outer layer is treated with at least one substance configured to react to increasing levels of thermal energy.

6. The system of claim 1, wherein the candle is a container candle and remains in an upright position independent of supporting devices.

7. The system of claim 1, wherein the design is positioned at an upper area of the candle, the positioning promoting the thermal energy to reach the design before wax of the candle is consumed.

8. The system of claim 1, wherein previous to the receipt of thermal energy by the outer layer, the static image is not visible.

9. A method for exposing an image on a candle, comprising:
an outer layer of a dual layer design affixed to an exterior surface of a candle detecting a thermal energy;
the outer layer, based on the detection, commencing a change of a substance one of comprising the outer layer and adhering to the outer layer;
the outer layer, based on the change, altering at least one of a color and opacity of the substance; and
the outer layer, based on the alteration, exposing a static image attached to an inner layer of the design.

10. The method of claim 9, further comprising the candle comprising a container candle.

11. The method of claim 9, further comprising the outer layer detecting the thermal energy based on a lighting of one of a single wick and multiple wicks of the candle.

12. The method of claim 9, further comprising the outer layer at least one of partially and completely covering the inner layer.

13. The method of claim 9, wherein the alteration comprises a transition of the heat-activated ink caused by the thermal energy.

14. The method of claim 9, further comprising the design initially receiving placement at an upper area of the candle, the placement promoting the thermal energy to reach the design before wax of the candle is consumed.

15. A method for progressively exposing an image affixed to a candle, comprising:
a candle radiating thermal energy based on at least one wick in the candle having been lit;
the candle heating an outer layer of an externally attached two-layer design based on the radiated thermal energy;
the candle, based on the energy, causing a substance at least one of coated onto and incorporated into the outer layer to dissipate; and
the candle, based on the dissipation, exposing a static image printed onto an inner layer of the design.

16. The method of claim 15, wherein the candle causing the dissipation comprises the substance changing at least one of colors and opacity of the outer layer.

17. The method of claim 15, further comprising the candle, via the outer layer, concealing the static image prior to the dissipation.

18. The method of claim 15, wherein the candle is a container candle with a container made of one of at least glass, ceramic or heat-resistant plastic.

19. The method of claim 18, wherein the container is one of translucent, transparent or opaque.

20. The method of claim 15, further comprising the design initially receiving placement at an upper area of the candle, the placement promoting the thermal energy to reach the design before wax of the candle is consumed.
